(19) United States
(12) Patent Application Publication
(10) Pub. No.: US 2010/0289615 A1
(43) Pub. Date: Nov. 18, 2010

(54) Electro-mechanical Leverlock with Switching System

(76) Inventor: Albert G. Adams, Mississauga (CA)

Correspondence Address: GOWAN INTELLECTUAL PROPERTY, 1075 NORTH SERVICE ROAD WEST, SUITE 203, OAKVILLE, ON, L6M-2G2, CA

(21) Appl. No.: 12/811,668

(22) PCT Filed: Jan. 7, 2009
(86) PCT No.: PCT/CA09/00020

§ 371 Date: Jul. 2, 2010

Related U.S. Application Data
(60) Provisional application No. 61/019,442, filed on Jan. 7, 2008.
(60) Provisional application No. 61/060,852, filed on Jun. 12, 2008.

(51) Int. Cl. E05B 43/00; E05B 47/06; G06F 7/04

(52) U.S. Cl. 340/5.2; 70/271

(57) ABSTRACT

A leverlock system is provided wherein an enclosure can be locked for a specified time period using a simple locking arrangement. The leverlock is intended to be used in conjunction with existing locking systems, and allows a user to restrict entry to anyone, including those who might otherwise be authorized to enter the enclosure, over a specified time period. A timer module is provide which activates a solenoid connected to a locking apparatus is provided, and the timer module controls the activation of the solenoid so that entry into the enclosure is only permitted for a selected interval duration, at a specific time. The leverlock system is also preferably accompanied by an Electrical/Electronic Switching System having a circuit which can be energized or de-energized by using a Random Access Memory—(RAM) Recognition Switching System™. The preferably auxiliary switching means is primarily used in conjunction with existing electrical/electronic switching circuits, and allows the primary user to restrict even those with secondary authority from energizing or de-energizing the circuit at other times. A temporary, randomly generated entry code is used to restrict access. The code is stored in memory for subsequent comparison with an inputted code value, which is preferably printed as a hard copy original of the code. Preferably, the code will not be erased from memory until used or reset by the primary user.

### FIELD OF THE INVENTION

The present invention relates to the field of locking devices, and in particular, relates to a locking device which can restrict access to an area, by an intruder, for a specified time period. To control the locking device, the present invention also relates to the field of Electrical/Electronic locking device Switching Devices, and in particular relates to a Switching Device which can at least temporarily restrict access to an area by an intruder when preferably used in conjunction with an existing Electrical/Electronic locking mechanisms, and preferably with the electro-mechanical leverlock described herein.

### BACKGROUND OF THE INVENTION

Conventional locking systems allow access entry and exit from enclosures which they secure and does not discriminate amongst possessors of keys, passwords, programmable codes, and the like, regardless of whether such access is obtained legitimately or otherwise. As such, anyone with such devices can gain access to the enclosures (be they rooms, buildings, safes, lockers, or any other “enclosures” that might be capable of being locked).

In the present application, the inventor seeks to provide a simple device which will prevent all access to the enclosure, by all parties, for a pre-set time period, so as to prevent intrusion (even by those with pass cards, keys, or the like). As such, it can act in conjunction with existing locking mechanisms, but provides improved and/or enhanced control of access to the enclosure.

In particular, the present device, hereinafter call a “leverlock”, provides a security advantage in that the user can be certain that no one else has intruded into the enclosure—even if they might otherwise be authorized to be in the enclosure at other times.

Moreover, to control such a leverlock, or other locking mechanisms, it is to be noted that conventional electrical/electronic switches allow for “making” and “breaking” within the circuits in which they are installed, once they have been provided with the appropriate key, code, password or the like. They do not, however, discriminate amongst possessors of these keys, passwords, programmable codes, and the like, when the switches are engaged and disengaged. This is true regardless of whether such making and breaking is invoked by a legitimate current users of said keys etc., or by other persons. As such, anyone in possession of a keys, password etc. can spontaneously energize or de-energize the electrical/electronic circuits of the different switching device circuitry systems at any time, and gain access to the enclosure.

In the present application, an electrical/electronic switching device is provided which will preferably at least temporarily prevent unauthorized use or manipulation by an “unauthorized” user so as to prevent intrusion (even by those who would normally otherwise have the appropriate identification access cards, keys, or the like). While the lock switching system can be independent of the main locking system, preferably, the switching means of the present invention acts in conjunction with existing electrical/electronic locking mechanisms.

However, the present switching device provides an enhanced security advantage to the user, in that the user can be certain that no one else has operated the switch, and thereby “illegally” engaged or disengaged the access-limited circuits that are controlled by the electrical/electronic switches or switching system; —even if they might otherwise be authorized at other times to control said electrical/electronic circuitry by means of aforementioned auxiliary switching means.

The switching system device is primarily intended to function in addition to, but can also replace, conventional electrical/electronic switching devices such as electrical key switches, key pads, ID access cards, and the like. A preferred switching system device will hereinafter called “RAM-Recognition Switching System”™.

Commonly, “Random Access Memory” or “RAM” is a term used to depict Temporary Data Storage Media wherein frequently replaced information is stored for a given period of time. This invention provides an enhanced latched switching system for which access will only be granted to its authorized user, and denied to all others. In particular, the switching system of the present invention preferably reconstructs its access identity on each departure from the enclosure, or, as often as its authorized user(s) so choose.

The present invention is preferably used to restrict access to an area by an intruder when used as an auxiliary component in conjunction with, for example, the Electro-Mechanical Lever Lock, described herein, and/or equivalent electrical/electronic locking devices. Also when installed by an original equipment manufacturer, the Switching system can be installed as a switching device for use in applications where temporary access restriction is desired, such as when used in conjunction with Cash Registers, Slot machines, or the like. As such, the device and system of the present invention can be used to temporarily lock devices which might otherwise be accessed by, or made operable by others. The RAM-Recognition Switching System™ might also be used as a switching device to temporarily control access to vehicles such as trucks or buses, for example, and the system can be retrofitted or installed by the original manufacturer.

The switching system can therefore act in conjunction with computer-controlled Access via Integrated Programmed Instructions stored in Read Only Memory (ROM), for example, and installed by the device manufacturer, so that it will perform its function in accordance within the teachings of this document.

### SUMMARY OF THE INVENTION

The advantages set out hereinabove, as well as other objects and goals inherent thereto, are at least partially or fully provided by the leverlock, and in particular, the electro-mechanical leverlock of the present invention, as set out herein below.

Accordingly, in one aspect, the present invention provides a leverlock, and preferably, an electro-mechanical leverlock, of the type described herein, and in particular, of the type described herein with reference to the drawings.

In particular, the present invention provide an electro-mechanical leverlock comprising a mechanical lock mechanism, a timer, and an electronic controller controlled by said timer, wherein said timer establishes pre-arranged time periods wherein said electronic controller allows said mechanical lock mechanism to operate.

The mechanical lock mechanism can be any suitable locking device, but preferably is a bar, or the like, which is moved into a position wherein opening the enclosure access (such as a door) is prevented. The bar can moved within brackets which allow such movement, by a solenoid type of device which is activated by the electronic controller. The electronic controller function is controlled by a timer which controls the electronic controller, and only allows the electronic controller to operate the solenoid (and thus move the bar) at specific, pre-arranged times, as discussed hereinbelow.

In a further aspect, the present invention also provides a method for preventing intrusion into an enclosure by use of the leverlock of the present application.

In the present invention, the leverlock, in an electro-mechanical embodiment, functions so as to prevent unauthorized intrusive access to within its user's enclosure by the use of a key, or other decoding manipulative means wherever pragmatically applicable.

It is to be noted that the device is not primarily intended to deter nor prevent break and enter. This function is preferably provided by other devices connected to the enclosure access. For example, a door knob on a door.

Instead, the purpose of this locking device and method is to ensure that no one enters the user's enclosure by intrusive means between the time of the user's departure from said enclosure and the user's subsequent sequential return to said enclosure. This includes preventing those with authorized access to the enclosure, at other times.

Its functional application therefore includes acting as a locking device, but with the significant exception that it denies spontaneous access or entry into the enclosure, from others. Instead, access into the enclosure only results at pre-existing or pre-arranged time(s), as set by the user.

Departure from within the enclosure's interior, to its exterior, is preferably not restricted, and/or can be easily overcome so as to allow rapid egress from the enclosure, if necessary.

The functional performance of this invention is accomplished by means of a leverlock having a timer function. The user resets the timer function within a timer module, prior to the authorized users departure from within said enclosure. Once closed, the leverlock prevents access to all parties for a predetermined period of time. In particular, it is preprogrammed only to allow an access interval at a specific point in time, at which Time Interval or Duration Interval, its user will have returned to gain entry. If the user has not returned by the appointed time interval, the authorized user will also be denied access for violating the process.

This invention will perform its functional application primarily to the enclosure main access openings having closing means including, preferably but not exclusively; firm enclosures such as premises, fire safes, freight containers, and the like.

The present approach has several differences from conventional locks and locking mechanisms.

Conventional locking systems allow access entry and exit from enclosures which they secure and does not discriminate amongst possessors of keys, passwords, programmable codes, or the like, whether such access means is obtained legitimately or otherwise.

However, on setting the present invention prior to departure from within its authorized user's enclosure, this system will discriminate and deny entry and/or access to the enclosure to the exclusion of all others, inclusive of the authorized user if the programmable reset is violated by the user. The authorized user has the option of sharing the preprogrammed time of entry with another authorized user(s) to the exclusion of all others.

The result of this system ensures that only the user, or those under the control of the user, can enter the enclosure, but only if the authorized programmed timer system and controls are not violated by its user.

The present invention will also have the provision of an access entry override in the event that authorized user has failed to respond to said user's preprogrammed time of entry.

The leverlock is preferably used in conjunction with a switching system which further controls the timer or timer function. As such, the present invention also provides a leverlock wherein a Random Access Recognition switching system is used to control and/or temporarily restrict access to the enclosure.

Accordingly, in a further aspect, the present invention also provides an enhanced Latched Switching means for preventing unauthorized duplication of a Reconstructed Access Identification for preventing intrusion into an enclosure by use of “RAM-Recognition Switching System”™, when used in conjunction with the leverlock, or with existing electrical/electronic locking mechanisms.

In the present invention, “RAM-Recognition Switching System”™ is either electronically integrated within the circuitry, or independently contained to perform its auxiliary switching function as described herein and will act in combination with electrical/electronic circuits including locking mechanisms, preferably with Electro-Mechanical Lever Lock, but not exclusively. “RAM-Recognition Switching System”™ will prevent unauthorized intrusive access to within its user's enclosure by the use of a key, or other decoding manipulative means wherever pragmatically applicable.

As with the leverlock, it is to be noted that the switching system device when used within and in conjunction with any of its applications herein is not primarily intended to deter nor prevent break and enter. Instead the purpose of this Switching Method is to ensure that no one enters the user's enclosure, or operates the “user's” device, by intrusive means between the time of the user's departure from the enclosure and/or device, and the user's subsequent sequential return. This includes preventing those who would have authorized access to the enclosure or device, at other times.

Its functional application therefore includes performing as an Electronic Switching Device, but with the significant difference of exclusively denying either spontaneous or prescheduled access to Unauthorized Intruders, but only allows spontaneous and/or prescheduled access entry to its authorized user(s). It accomplishes this function by generating a temporary, and preferably random, entry or access code that is only provided to the user.

The present invention differs from conventional switches in that a conventional switch energizes a locking circuit to restrict access. As such, the conventional switches restrict entry and exit from the enclosure or device which they secure. However, when granting access to the enclosure, they do not discriminate amongst possessors of keys, programmable codes and pass word devices or the like, whether such access means is obtained legitimately or otherwise.

However, on performing the procedure of the present invention prior to departure or closing of the enclosure or device, by the authorized user, the present invention will now discriminate and deny everyone other than the user, spontaneous or prescheduled access entry to the enclosure. The authorized user does, however, have the option of sharing the randomly generated, entry code with other authorized users. The code is preferably generated by “RAM-Recognition Switching System”™ in the form of a randomly generated one-of-a-kind hard copy printout.

The system thereby ensures that only the user, and those allowed by the user, can enter the enclosure or use the device, because its modified access configuration can be changed as often as its authorized user desires.

The access entry override system will preferably, but optionally, incorporate an analogue/digital electronic timer that is integrated within the switching system and is preset prior to departure for a specific access time interval. This timer, which can be included as part of the time function of the leverlock, can restrict access for a specified time period, or can be used to establish a time period in which only the code is usable. The time interval can be chosen so as to allow for contingencies that comfortably meets or exceeds the expected time of return to the enclosure or device, on any given time period, day, or even over a longer period.

In use with the leverlock, the switching system can be used to allow access to the enclosure, using the temporary, randomly generated entry code, during the time when the leverlock is enabled. However, the switching system might also be used to generate an entry code which overrides the leverlock function. This would be useful in the situation where, for example, one user might have unrestricted access using the randomly generated entry code from the switching system, while others might be granted access at other times permitted by the leverlock function.

Conventional electrical/electronic Switching devices respond when they recognize an action taking by a normal user. However, even if this action is recognized by the system of the present invention, if the new access code is not entered, then the switch will not change its position from Make to Break, or Break to Make as the case may be.

As such, in accordance with the invention, the system preferably changes its Access configuration during each Reset (which could be several times daily, or as often as its authorized user desires). The access configuration can be varied depending on the level of security that is required.

Accordingly, in a further aspect, the present invention provides a switching system comprising an entry code generator to generate randomly generated, temporary entry codes, an locking device activator to engage an enclosure locking mechanism, and an entry code validator to compare an entered entry code to a record of said randomly generated, temporary entry codes, wherein on entry of a valid entry code into said entry code validator, said locking device disengages.

The entry code generator can provide electronically generated entry codes, but preferably, the entry codes are generated by mechanical means, as described hereinbelow. This minimizes the possibility of electronic interception of the entry code by unauthorized users.

### DETAILED DESCRIPTION OF THE INVENTION

In the present application, the term “RAM Recognition” refers to an electrical/electronic Switching Device—an auxiliary component that is locally or remotely connected to an electrical/electronic circuit which in its entirety will cause said circuit to perform its required security function or discontinue such function.

The skilled artisan will be aware that other devices such as Key Switches, I.D. Access Cards, and the like might also be used. Accordingly while the present application is described with particular reference to electrical/electronic switches, the skilled artisan would be aware that the present application would be equally applicable in other, preferably, electrical/electronic switching applications.

Further, in the present application, the term “electro-mechanical leverlock” refers to a locking device that is connected to a mechanical system as part of the lock. This may be a specific device attached to an enclosure in addition to an existing lock. Alternatively, the leverlock may be a totally new lock that is fitted to an enclosure, or can be added to a conventional lock structure. The leverlock of the present invention is primarily simply directed to a mechanical structure that acts as a barrier to entry into the enclosure.

The skilled artisan will be aware that other devices which are primarily not mechanical, such as magnetic locking devices, might also be used. Accordingly, while the present application is described with particular reference to a mechanical system, the skilled artisan would be aware that the present application is equally applicable in other non-mechanical applications.

Further, unless otherwise specifically noted, all of the features described herein may be combined with any of the above aspects, in any combination.

### BRIEF DESCRIPTION OF THE DRAWINGS

Embodiments of this invention will now be described by way of example only in association with the accompanying drawings in which:

FIG. 1 is a perspective drawing of one embodiment of the invention;

FIG. 2 is a perspective drawing of a second embodiment of the invention;

FIG. 3 is a representative view of an AC/DC Timer (10) having Output Receptacle Jack Connector (11), and optional AC Conductor Cable (12), or AC Male Plug;

FIG. 4 is a representative view of a Hand Held (14) Random Character Generator (115) having LCD Display (113), and comprising Control Push Buttons, including Reset Button (152);

FIG. 5 is a side elevation view of FIG. 2, (115);

FIG. 6 is a front view of a Control Computer (120), comprising Internal RAM memory, having Push Button Controls, including Reset Button (152), and Output Interface Connector (116), with LCD Display (121);

FIG. 7 is a perspective view of a Hand Held, or Automated Photo Box (130), comprising hollow enclosure to house loosely placed object entities (135), and Diffused Lighting (160) around its perimeter surrounds to eliminate shadows within;

FIG. 8 is a top cut-away view of (130) showing a collection of Object Entities (135) agitatedly and randomly positioned;

FIG. 9 is a perspective view of a typical Object Entity (135) with surface markings (118) for enhanced Identity;

FIG. 10 is a view of a Print-out Card (150) Reception Slot mounted to Access Door, or external adjacent Areas;

FIG. 11 is a view of a Camera/Scanner (140) for use in (130) having Input/Output Interface Connector (167);

FIG. 12 is a view of an Image Card Printer (145), having Print-out Cards (150) Spool, and Control Push Buttons (152);

FIG. 13 is a view of an Image Print-out (150) of a Randomly positioned Object Entities (135) Image view;

FIG. 14 is a view of another Image Print-out (150) of a Randomly Generated Bar Code Image view of Prior Art or Otherwise Original;

FIG. 15 is a further view of another Image Print-out (150) of a Randomly Generated Character Series Image view of Prior Art or Otherwise Original;

FIG. 16 shows still another Image Print-out (150) of a Randomly Generated Character Series Image view of Prior Art or Otherwise Original; and

FIG. 17 Reveals USB, Serial, or other Signal Conductor Cable of Prior Art (155).

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example only. In the drawings, like reference numerals depict like elements.

It is expressly understood, however, that the drawings are for the purpose of illustration and description only and are not intended as a definition of the limits of the invention.

A partial list of the requisite and optional components of a typical leverlock, in accordance with the present invention, is as follows:
1) AC/DC Solenoid
2) Analogue or Digital Programmable Timer
3) Solenoid plunger
4) Pilot LED to indicate deadbolt release
5) SPDT Master Switch
6) Levers, Cables or equivalent
7) Switch
8A and 8B) Tension or Compression Springs
9) Fulcrum Pins
12A, 12B and 12C) Retaining or Deadbolt Brackets
13A and 13B) Lever locking apparatus (bars)

Additional components in a more advanced model, can include:
14) Time Delay Relay (TDR) to allow for exit before system activation
15) AC Surge Suppressor and/or Uninterrupted Power Supply (UPS), or equivalent
16) Keypad or other password device etc. to energize solenoid (1)
80) Stop Plunger Opening

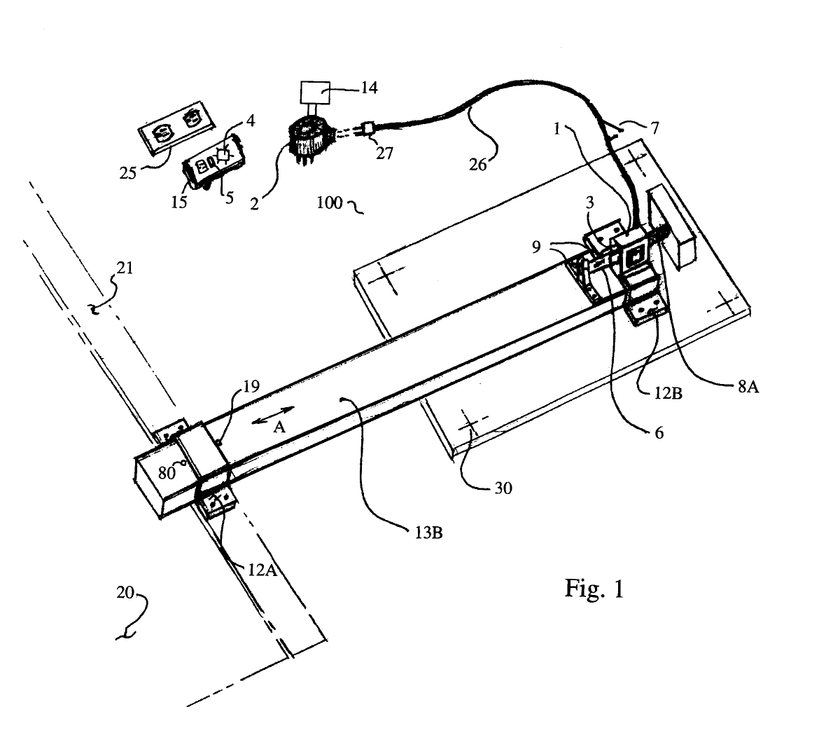

Referring to FIG. 1, a leverlock (100) is provided wherein a bar (13), as a lever locking apparatus, is used to prevent a door (20) from opening. The leverlock (100) apparatus is mounted on the inside of the structure (not shown), and is typically mounted on a base (30) which can be mounted on a wall or other structure near door (20).

Leverlock (100) is assembled by means of its principal components comprising a solenoid (1), a solenoid plunger (3), and having at least one lever (6) and fulcrum pins (9), or cable and pulley wheels equivalent. One end of Lever (6) is axially aligned, registered, and attached to the driving plunger (3) of solenoid (1), having the opposite end of lever (6), or cable, axially aligned and registered to the aforementioned mechanical closing/locking apparatus.

Precision measurements are also ensured to enable the maximum extension of lever locking apparatus (13B) within brackets (12A) and (12B). This extension length may be directly related to the distance of the plunger (3) movement, or can be reduced or increased, as desired, by additional mechanical linkages (not shown). A pin (19) prevents bar (13B) from overextending.

A Power Supply (AC or DC) is installed in accordance with the power specifications of Solenoid (1). For example, an optional Uninterrupted Power Supply and/or surge suppressor (15) can be incorporated, and can be securely affixed and mounted upon AC Receptacle (25), which acts as an AC power source. Optionally, however, batteries as a DC power source might be used.

A Programmable Timer module (2) is plugged within and securely affixed to surge suppressor (15) (mounted to AC receptacle (25)), wherein Solenoid AC power conductor leads (26) having AC connector (27) can be securely plugged and fastened upon. The system is now located, aligned in position and mounted, using a base section (30), to a structure adjacent to door (20).

Vibration Dampers (not shown) might also be included to minimize any vibratory noises when the solenoid (1) is energized.

Leverlock (100) is now ready to be put into operation.

### Method of Operation:

Prior to leaving the enclosure, the user programs the Timer (2) in order to schedule his/her expected time of return and schedules an Interval duration within which said Solenoid (1) will be energized, and will remain energized, thus allowing the authorized user to gain access to the enclosure during that specific interval in time. The Interval duration selected can be any suitable time period, but typically would be a time period from 1 minute to 1 hour, and preferably, between 2 to 15 minutes.

An optional Timer Interval Override time period is also preferably preprogrammed within the timer thereby allowing further attempts at entry by said user if the first attempt at entry was missed. It should be noted, however, that the more Timer Interval Overrides that are scheduled, the more the integrity of the system and its functional purpose, is decreased.

Spring (8A) is connected to the end of bar (13A), and normally pushes bar (13B) into the position shown in FIG. 1. Bar (13B) rides in brackets (12A and 12B) provided to hold bar (13B) in place. Bracket (12A) is conveniently mounted on door frame (21), while bracket (12B) can be mounted to base (30). Once bar (13B) is in place, it acts as a barrier to the movement of door (20). This is preferably in addition to a typical door lock (not shown) that might be fitted to door (20).

However, once the schedule time of return is reached, solenoid (1) activates and causes the retraction of plunger (3). Through lever (6), the retraction of plunger (3) causes bar (13B) to also retract, and thus move away from being in a position to contact door (20). As a result, the user can open door (20) and enter the room.

After the specified Interval duration, the solenoid de-activates, and allows bar (13B) to return to the position shown in FIG. 1 via the action of spring (8A). Should the user miss this Interval duration period, he/she is forced to wait until the next Interval duration (which might be the same time on the following day), or until a Timer Interval Override occurs, in order to enter the room.

Optionally, a time delay relay (14) can be fitted to the leverlock system (100) so as to be activated for a period of, for example, 10 to 20 minutes after the system has been first programmed. This relay keeps solenoid (1) activated for the set period of time, and thus, allows the user to exit through the door without difficulty, and possibly immediately return into the room if something is forgotten, or the like.

In normal use, when the user returns and enters the enclosure, he may deactivate solenoid (1) during the Interval duration, by means of a Master Switch (5), at which time bar 13(A) will return to its normally closed position. This will occur as a result of the action of the force of spring (8A) unless a pin (not shown), or equivalent, is manually inserted into bar (13A) using an optional stop plunger hole (80) while bar (13A) is in its open position. This will allow free and easy access to the enclosure through door (20) without any risk of being inadvertently locked out of the enclosure via the spring loaded action of bar (13A).

An optional LED (4) pilot light can be provided that provides visual confirmation that power is reaching the system when Master switch (5) is in the ON position. In this manner, the user can determine whether solenoid (1) is, or can be, activated or not. A luminous switch might also be used instead.

As indicated above, Master switch (5) ensures that solenoid (1) is prevented from being activated unless switch (5) is engaged. This permits the user to activate solenoid (1) only as required during the Interval duration, but otherwise, prevents solenoid (1) from activating for the full Interval duration, if not needed. As such, the user can override the system after entry into the enclosure.

An optional switch (7) can be provided to also prevent solenoid (1) from activating, in the same manner as hereinabove described, while allowing power to continue to pass to timer unit (2).

Through these actions, the system prohibits those who might have keys etc. from entering the enclosure during the Interval duration, unless they now also know the operational parameters of leverlock (100).

It is to be noted that this embodiment is one wherein the solenoid (1) has a plunger (3) which pulls on bar (13B), and wherein a spring (8A) is used to hold bar (13B) in an activated position. Those skilled in the art will understand that various solenoids and/or alternative solenoid positions, and the spring arrangements, can be used wherein plunger (3) can either pull or push on bar (13B) to move it into place. Further, the system can be modified so that solenoid (1) is activated (instead of deactivated) in order to move bar (13B) into the active position (although this is not typically preferred for power consumption reasons).

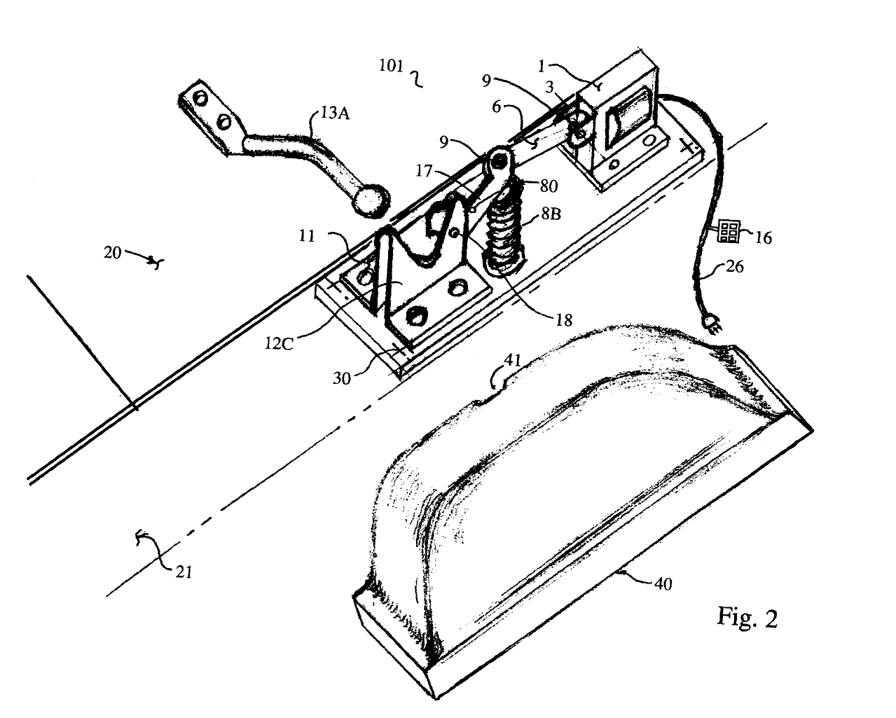

In FIG. 2, a similar leverlock device (101) is shown which is in an “open” position. For leverlock (101), spring (8B) is used to move a locking arm (17) into a position wherein it locks bar (13A) within the structure of bracket (12C). In operation during the Interval duration, solenoid (1) activates to pull, through plunger (3) and lever (6) and fulcrum pins (9), arm (17) downwards and thus compress spring (8B). This “opens” arm (17) in bracket (12C), and allows bar (13A) to be inserted or removed. At the end of the Interval duration period, however, solenoid (1) is deactivated. This deactivation allows spring (8B) to extend, and raise arm 17 so that it pivots around pin (18) on bracket (12C). As a result, arm (17) returns to a “closed” position wherein bar (13A) is held within bracket (12C). As a consequence, door (20) cannot be opened.

A protective cover (40) is shown which can be fitted over leverlock (101), and includes a slot (41) in which bar (13A) can be moved.

A pin can also be inserted into stop plunger opening (80) to hold arm (17) in an open position, in a manner similar to that described with respect to FIG. 1.

In this example, a keypad (16) is provided which is located outside of the enclosure, and which can be utilized to cause solenoid (1) to be activated during the Interval duration. Thus, additional security is provided by having a keypad in which a user defined password is required to activate solenoid (1), and thus release door (20).

Again, the specific arrangement of springs and operation of the solenoid can be adjusted as required by the skilled artisan.

In general, however, the locked position of bar (13B) of FIG. 1, and Arm (17) of FIG. 2 will be preferably driven and held in place by spring (8A) and (8B) respectively, as opposed to continuous solenoid activation. Solenoid (1) preferably only energizes during the Interval duration, and therefore, solenoid (1) works only during the access period, as established on the timer. This aids in maximizing the useful life of solenoid (1), as well as reducing power consumption.

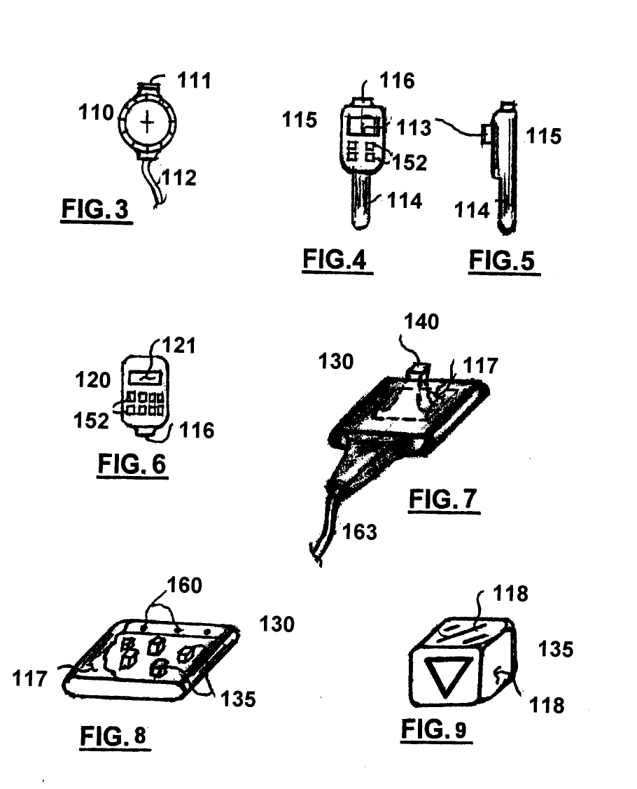

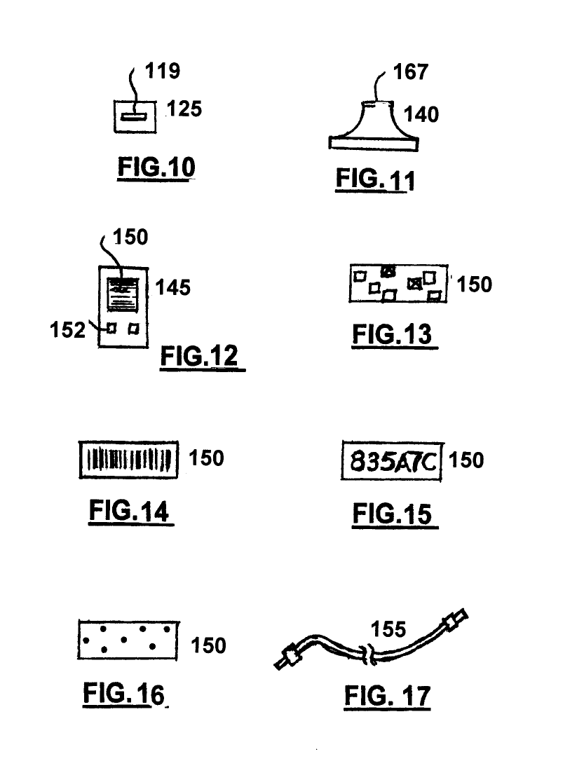

In FIG. 3, a “RAM-Recognition Switching System” of particular utility in the present invention is shown. A partial list of the requisite components of the in accordance with the present invention is as follows:
(110)—AC/DC Analogue/digital Programmable Override and Access Time Interval Timer.
(115)—A Computerized Random Character Generator, or Random Bar Code Generator.
(120)—Computer with RAM memory for Reading and Comparing Images.
(130)—An Automated, or hand held Photo Box Image Container having Entity Scanner.
(135)—A series of small objects of Cube like—Flat Sided Entities, or equivalent—to be loosely placed within and sealed for movement within (130) above.
(140)—Entity Scanner for Randomly generated Images within (30).
(145)—A substantial business card sized—Scanner and Hard Copy Printer of Prior Art or otherwise, for printing Randomly generated configurations.
(150)—Access Print-out Cards
(155)—USB, Serial, or other Signal Conductor Cables.

It is to be noted that the “RAM-Recognition Switching System” can be fitted to the leverlock system of FIGS. 1 and 2, as part of the Analogue or Digital Programmable Timer (2), and acts by memorizing a Randomly Generated series of Characters (115), or Bar Code (115), or a number of Object Entities (135) that are either automatically or manually agitated by authorized user then Scanned (140), whose Images are Stored in RAM memory (120) from whence Print-outs are generated (150) by Authorized User for Comparison on subsequent Return of authorized user to the enclosure. The Scanner will perform Two Functions, namely:

a) Scans the Randomly placed Object Entities (135) within the Photo Box (130).

b) Scans Access Print-out Cards (150) for Comparison by aforementioned RAM (120) Recognition Device.

An electrical/electronic switching system wherein a circuit will be Energized or De-energized by means of a Random Access Memory (RAM) Recognition Switching process.

In order to accomplish this, a computerized Random Character, or Bar Code Generator, or equivalent Random Generating means will be provided so as to generate alphanumeric or other characters in a random fashion each time a Reset is performed.

An Image Container (130) comprising Cube like Object Entities (135) that are loosely placed within said Photo Box (130), having flat sides and rounded corners that are physically configured for movement so as to allow for a temporary, locationally stable platform whereby Fixed Imagery will be formed long enough to allow for Scanning within said Image Container (130), comprising diffused illumination, and a substantial Resolution in order to produce a distinct and clear Scanned Image depicting the contrast between the Random production of said Entities housed within said entity enclosure and their back ground surfaces in which they are housed. Said Imagery Randomly changes each and every time said Random Generator is invoked, or the Entity Container is agitated manually or automatically during the Reset process, at which time aforementioned Random Character, or Bar Code Generator, or Entity Imagery is recognized as in the case of the former two, or scanned as in the case of the latter, whichever of these individual temporary image produced in processes will be stored in aforementioned RAM memory, or Volatile Memory, or IC Chip, or equivalent.

Preferably, at least two hard copy print-out (150) replica will be dispensed from a printer (145) in substantial business card sized copies (150); —the desired quantity and size of the print-out (150) being at the discretion of the authorized user. This Image Value will be retained in said RAM memory until a subsequent Reset by Primary authorized user is performed, wherein said RAM will initialize and data retained within will be erased to accommodate the new Randomly Generated Value.

The Random Generation, and production of a hard copy Print-out (150) in accordance with the above processes by any of the methods described herein will be invoked and performed by authorized user prior to his/her departure from firm enclosure, and during the Reset process.

Authorized user now locks the enclosure and departs. On the user's subsequent sequential return to said enclosure, authorized user will place the hard copy print out (150) within a card reader (125) or equivalent of Prior Art or otherwise, wherein a Image Comparison is performed by (120) between the image that is on said hard copy (150) and that which is stored in RAM memory, If there is an identical match then the RAM Recognition Switch will Make, or Break thereby causing aforementioned Circuit to Energize or De-energize as the case may be, which in turn will fulfill the functional application for which the Switching System is intended to perform.

The above procedure will be performed regardless of whichever of the above method is used, and will function in like manner each and every time the “RAM-Recognition Switching System” is Reset prior to departure by the authorized user. At each Reset, said switching system will initialize wherein RAM memory is erased then a New series of Randomly generated characters, or Bar Code equivalent (115) is generated, or a Unique Image is generated (130) and scanned. Whichever method is employed, Said Generated Value will be remembered and stored in computerized RAM memory for comparison with hard copy print out (150) on authorized user's return to firm enclosure. Prior to departure from the enclosure, authorized user will now order a specific amount of Print-outs (150) of said Images. At least Two copies will be preferably generated in the event that one copy is lost or defaced, and should be kept on the person of the authorized user, or with whom said authorized user so chooses, in his/her possession at all times in a firm case, or bill fold to prevent folding, creasing or defacing.

Of course, the system might merely generate an electronic code to be memorized by the user, but preferably, a hard-copy is provided for comparison to the scanned and stored image.

On completion of the Printed process the Buffer of said Printer will automatically be Erased, and communication between said Printer and computer will no longer be able to Interface with each other in order to generate Unauthorized Access Print-out copies (150), until subsequent sequential Reset is invoked. RAM memory will still Retain its Pre-programmed Access Data for Comparison on User's return. If comparison is identical, said “RAM-Recognition Switching System” will Make or Break thereby energizing or De-energizing the circuit to which it is connected. This represents one full Functional Cycle of the RAM Recognition Switching Embodiment.

The functional performance of this invention is accomplished when used as an auxiliary component in combination with an electrical/electronic Circuit that requires some level of security such as Electro-Mechanical Lever Lock, or other devices. When “RAM-Recognition Switching System”™ is used in combination with a lever lock, a Timer (110) may or may not be included. If the Timer is incorporated, it will increase the level of intrusive protection wherein access may be granted within a Preset Time Interval during which Time Interval only will allow aforementioned Print-out (150) to be Read and Compared with Randomly Generated Images. “RAM-Recognition Switching System”™ is invoked by its authorized user, as in the case of the Electro-Mechanical Lever Lock thereby energizing the Lever Lock, whereby access is allowed.

It must be noted that “RAM-Recognition Switching System”™, when used in conjunction with a Timer, will not be functionally effective at any time during the Timer (110) pre-programmed protected duration except only within said Access Timed Interval period, and cannot override the pre-programmed time frame but will only be functionally enabled during the Pre-programmed Time Interval. Said Timer may also be simultaneously Pre-programmed as an Access Override in the event that the Scheduled Access Time Interval has expired. If this Time Interval has expired, then the Pre-programmed Access Override will allow Access Print-out (150) to be Read and Compared at a Preset Override Advanced Time Period.

This invention will perform its functional application primarily to main access openings having closing means including preferably but not exclusively firm enclosures such as premises, fire safes, freight containers, and the like, and/or control access to devices such as cash registers, slot machines, computers, and the like.

Thus, it is apparent that there has been provided, in accordance with the present invention, a electro-mechanical leverlock and switching system which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

Moreover, the words “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “he”, “him”, or “his”, is not intended to be specifically directed to persons of the masculine gender, and could easily be read as “she”, “her”, or “hers”, respectively.

Also, while this discussion has addressed prior art known to the inventor, it is not an admission that all art discussed is citable against the present application.

We claim:

1. An electro-mechanical leverlock comprising a mechanical lock mechanism, a timer, and an electronic controller controlled by said timer, wherein said timer establishes pre-arranged time periods wherein said electronic controller allows said mechanical lock mechanism to operate.

2. An electro-mechanical leverlock as claimed in claim 1 wherein said mechanical lock mechanism is a bar which is moved into a position wherein opening the enclosure access is prevented.

3. An electro-mechanical leverlock as claimed in claim 2 wherein said bar is moved within brackets which allow such movement.

4. An electro-mechanical leverlock as claimed in claim 2 wherein said bar is moved by a solenoid which is activated by the electronic controller.

5. An electro-mechanical leverlock as claimed in claim 4 wherein said electronic controller function is controlled by a timer, and only allows the electronic controller to operate the solenoid, and thus move said bar, at specific, pre-arranged times.

6. An electro-mechanical leverlock as claimed in claim 1 additionally comprising a switching system comprising an entry code generator to generate randomly generated, temporary entry codes, an locking device activator to engage an enclosure locking mechanism, and an entry code validator to compare an entered entry code to a record of said randomly generated, temporary entry codes, wherein on entry of a valid entry code into said entry code validator, said locking device disengages.

7. An electro-mechanical leverlock as claimed in claim 6 additionally comprising an analogue or digital electronic timer that is integrated within the switching system and is preset prior to departure for a specific access time interval.

8. An electro-mechanical leverlock as claimed in claim 6 wherein said timer restricts access for a specified time period, or can be used to establish a time period in which only the code is usable.

9. An electro-mechanical leverlock as claimed in claim 6 wherein said switching system provides electronically generated entry codes, or provides entry codes generated by mechanical means.

10. A switching system comprising an entry code generator to generate randomly generated, temporary entry codes, an locking device activator to engage an enclosure locking mechanism, and an entry code validator to compare an entered entry code to a record of said randomly generated, temporary entry codes, wherein on entry of a valid entry code into said entry code validator, said locking device disengages.

11. A switching system as claimed in claim 10 wherein said switching system provides electronically generated entry codes, or provides entry codes generated by mechanical means.
